(19) United States
(12) Patent Application Publication
(10) Pub. No.: US 2026/0160567 A1
(43) Pub. Date: Jun. 11, 2026

(54) IDENTIFY THE POI VISITED USING THE TSE ALGORITHM

(71) Applicant: HERE Global B.V., Eindhoven (NL)

(72) Inventors: Amarnath NAYAK, Borivali East (IN); James Adeyemi FOWE, Chicago, IL (US)

(21) Appl. No.: 18/974,236

(22) Filed: Dec. 9, 2024

(51) Int. Cl. G01C 21/34; G01C 21/36

(52) U.S. Cl. CPC G01C 21/3476; G01C 21/3617; G01C 21/3682; G01C 21/3685

(57) ABSTRACT

The disclosure provides a system and method to identify the point of interest using the trip start and end algorithm. The system receives trip data associated with each of a plurality of data points of a trip segment of a trip. The system determines a deceleration condition associated with a set of consecutive data points. Further, in response to determining deceleration condition, the system determines a geographical region associated with set of consecutive data points. Further, the system determines geographical region to be associated with a point of interest (POI) location. The system determines, using a machine learning (ML) model, a probability value for occurrence of a stop event of trip based on the determined geographical region to correspond to the POI location. Based on the determination of the probability value to be greater than threshold value, the system stores the trip data in association with stop event of trip.

### TECHNICAL FIELD

The disclosure relates to the field of Intelligent Transportation Systems (ITS), and more specifically to a system and a method for identifying the point of interest (POI) visited using the trip start and end (TSE) algorithm.

### BACKGROUND

Trip data, typically collected from various original equipment manufacturers (OEM), provide valuable insights into travel patterns and behaviors across various transportation modes. Analyzing this data can reveal critical aspects of travel behavior, including route choice, travel patterns, driver behavior, and traffic demand. However, the trip data is anonymized to protect user privacy by periodically truncating, thereby resulting in multiple trip IDs for a single origin-destination (OD) trip. This implies that a continuous trip is split into several segments, each segment has its unique trip ID. Further, there may be gaps between successive trip IDs due to truncation, thereby complicating tracking of the complete OD trip.

In general, the trip officially begins at the origin when a vehicle starts from a rest position and ends at the destination when the vehicle is parked back. However, if the trip ID changes near a point of interest (POI) other than the destination of the OD trip, then it becomes inconclusive whether it was only a trip ID rotation or whether the trip ended at the POI. Consequently, there is a need for a system and method that can efficiently collect and process trip data from vehicles to extract useful information while determining whether that trip ended at the POI or is just a continuation of the larger journey.

### SUMMARY

The present disclosure provides systems and methods for identifying the point of interest (POI) visited using the trip start and end (TSE) algorithm. Some example embodiments are directed towards analyzing trip data associated with a trip of a vehicle. The trip data may include information such as speed information, location information, orientation information, lane information, time information, or the like associated with one or more vehicles. According to some example embodiments, the trip data stored in the multi-purpose trip database may be utilized to determine the probability that a trip ended at the POI. In some embodiments, the trip data may be provided as dynamic content data to other service providers, while protecting personal identifiable information (PII) associated with probe data using which the trip data is generated. In an embodiment, the TSE algorithm is applied on the probe data and if the output of the TSE algorithm indicates that the trip ended near the POI, then the system further determines, using a machine learning algorithm, a stop event of the vehicle near the POI. This approach allows for the determination of a probability that the trip ended at the POI.

In one aspect, a system for identifying the POI using the TSE algorithm is provided. The system may include a memory configured to store computer-executable instructions, and at least one processor configured to execute the computer-executable instructions. The processor may be configured to receive trip data associated with each of a plurality of data points of a trip segment of a trip. The trip data includes speed data and location data. Further, the processor may be configured to determine a deceleration condition associated with a set of consecutive data points of the plurality of data points. The set of consecutive data points terminates at an end point of the plurality of data points. Further, in response to determining the deceleration condition, the processor may be configured to determine a geographical region associated with the set of consecutive data points based on the location data of each data point of the set of consecutive data points. The processor may be configured to determine the geographical region to be associated with a point of interest (POI) location. The processor may be further configured to determine, using a machine learning (ML) model, a probability value for the occurrence of a stop event of the trip based on the determined geographical region to correspond to the POI location. Furthermore, based on the determination of the probability value to be greater than a threshold value, the processor may be configured to store the trip data in association with the stop event of the trip.

In additional system embodiments, the trip data is associated with the trip of a vehicle, and the deceleration condition is associated with the deceleration of the vehicle.

In additional system embodiments, the processor may be further configured to identify the set of consecutive data points. The set of consecutive data points includes a pre-defined number of consecutive data points of the plurality of data points. Further, the processor may be further configured to determine a first value associated with the set of consecutive data points based on the speed data associated with each data point of the set of consecutive data points. The first value indicates one of an acceleration of the vehicle, or the deceleration of the vehicle.

In additional system embodiments, on determining the geographical region to be associated with the POI location, the processor may be further configured to determine a time period associated with the stop event of the vehicle within a vicinity of the POI location. Further, the processor may be further configured to compare the time period of the stop event with a time threshold. Thereafter, the processor is further configured to determine the POI location to be associated with a parking area based on the comparison.

In additional system embodiments, the processor may be further configured to obtain map data. The map data comprises a plurality of POI locations. Further, the processor may be further configured to compare the determined geographical region with each of the plurality of POI locations. Furthermore, the processor may be configured to determine the geographical region to be associated with the POI location of the plurality of POI locations based on the comparison.

In additional system embodiments, the trip segment is associated with a trip identifier.

In additional system embodiments, the trip data further includes lane information of the vehicle associated with each of a plurality of data points, and orientation information of the vehicle associated with each of a plurality of data points.

In additional system embodiments, the processor may be further configured to determine, using the ML model, the probability value for the occurrence of the stop event based on the lane information of the vehicle associated with each of the set of consecutive data points, and the orientation information of the vehicle associated with each of the set of consecutive data points.

In additional system embodiments, the processor may be further configured to receive historical data associated with the POI location. Further, the processor may be configured to determine vehicle data associated with the POI location based on historical data, The vehicle data is associated with one or more parked vehicles within a threshold distance from the POI location. Furthermore, the processor may be configured to determine, using the ML model, the probability value associated with the occurrence of the stop event of the trip based on the vehicle data.

In additional system embodiments, the processor may be configured to re-train the ML model based on the trip data, and historical data associated with the POI location and store the re-trained ML model.

In additional system embodiments, the processor may be further configured to determine POI information from map database. Further, the processor may be configured to generate, using the ML model, a label corresponding to the trip segment. The labels indicate the POI information corresponding to the stop event. The processor may be further configured to store the trip data in association with the labels.

In additional system embodiments, the ML model is trained on a historical trip data associated with one or more vehicles. The processor may be configured to train the ML model based on the historical trip data to determine the probability value for the occurrence of the stop event of the trip.

In another aspect, a method for identifying the POI using the TSE algorithm is provided. The method may include receiving trip data associated with each of a plurality of data points of a trip segment of a trip. The trip data includes speed data and location data. Further, the method may include determining a deceleration condition associated with a set of consecutive data points of the plurality of data points. The set of consecutive data points terminate at an end point of the plurality of data points. Further, in response to determining the deceleration condition, the method may include determining a geographical region associated with the set of consecutive data points based on the location data of each data point of the set of consecutive data points. The method may include determining the geographical region to be associated with a point of interest (POI) location. The method may include determining, using a machine learning (ML) model, a probability value for occurrence of a stop event of the trip based on the determined geographical region to correspond to the POI location. Furthermore, based on the determination of the probability value to be greater than a threshold value, the method may include storing the trip data in association with the stop event of the trip.

In additional method embodiments, the method may include identifying the set of consecutive data points. The set of consecutive data points includes a pre-defined number of consecutive data points of the plurality of data points. Further, the method may include determining a first value associated with the set of consecutive data points based on the speed data associated with each data point of the set of consecutive data points. The first value indicates one of an acceleration of the vehicle, or the deceleration of the vehicle.

In additional method embodiments, on determining the geographical region to be associated with the POI location, the method may include determining a time period associated with the stop event of the vehicle within a vicinity of the POI location. Further, the method may include comparing the time period of the stop event with a time threshold. Thereafter, the method may include determining the POI location to be associated with a parking area based on the comparison.

In additional method embodiments, the method may include obtaining map data. The map data comprises a plurality of POI locations. Further, the method may include comparing the determined geographical region with each of the plurality of POI locations. Furthermore, the method may include determining the geographical region to be associated with the POI location of the plurality of POI locations based on the comparison.

In additional method embodiments, the trip data further includes lane information of the vehicle associated with each of a plurality of data points, and orientation information of the vehicle associated with each of a plurality of data points.

In additional method embodiments, the ML model is trained on a historical trip data associated with one or more vehicles. The method may include training the ML model based on the historical trip data to determine the probability value for the occurrence of the stop event of the trip.

In yet another aspect, a computer programmable product is provided. The computer programmable product comprises a non-transitory computer readable medium having stored thereon computer executable instructions, which when executed by one or more processors, cause the one or more processors to conduct operations. The operations may include receiving trip data associated with each of a plurality of data points of a trip segment of a trip. The trip data includes speed data and location data. Further, the operations may include determining a deceleration condition associated with a set of consecutive data points of the plurality of data points. The set of consecutive data points terminate at an end point of the plurality of data points. Further, in response to determining the deceleration condition, the operations may include determining a geographical region associated with the set of consecutive data points based on the location data of each data point of the set of consecutive data points. The operations may include determining the geographical region to be associated with a point of interest (POI) location. The operations may include determining, using a machine learning (ML) model, a probability value for occurrence of a stop event of the trip based on the determined geographical region to correspond to the POI location. Furthermore, based on the determination of the probability value to be greater than a threshold value, the operations may include storing the trip data in association with the stop event of the trip.

In additional computer programmable product embodiments, the operations may include identifying the set of consecutive data points. The set of consecutive data points includes a pre-defined number of consecutive data points of the plurality of data points. Further, the operations may include determining a first value associated with the set of consecutive data points based on the speed data associated with each data point of the set of consecutive data points. The first value indicates one of an acceleration of the vehicle, or the deceleration of the vehicle.

With the ongoing industry segments, road traffic is sensed with the use of vision sensors, which do not cover the car's vision. To overcome this, some embodiments are directed towards using the car's vision to sense the road traffic. Some embodiments provide an ability to create a comprehensive suite of analytical insights that may refine the extraction of trip data from the probe data. The current invention provides an efficient architecture for extracting the trip data. The extracted trip data may be gathered in a timely manner and may be provided to other service providers. The trip data may be compatible with map technologies and may ensure at the same time that the privacy of the user from where the trip data was extracted is maintained.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a schematic diagram of a network environment in which a system for identifying the POI using the TSE algorithm is implemented, in accordance with an embodiment of the disclosure;

FIG. 2 illustrates a block diagram of the system of FIG. 1, in accordance with an embodiment of the disclosure;

FIG. 3A and FIG. 3B jointly illustrate a flowchart of a method for determining a probability value for an occurrence of a stop event, in accordance with an embodiment of the disclosure;

FIG. 4 illustrates exemplary operations for determining the probability value for the occurrence of the stop event using a machine learning model, in accordance with an embodiment of the disclosure;

FIG. 5 illustrates a schematic diagram depicting a plurality of data points of a trip segment of a trip, in accordance with an embodiment of the disclosure;

FIG. 6 illustrates a schematic diagram of an exemplary POI, and a footprint associated therewith, in accordance with an embodiment of the disclosure;

FIG. 7 illustrates a flowchart of a method for identifying the POI using the TSE algorithm, in accordance with an embodiment of the disclosure;

FIG. 8 illustrates an exemplary map database record storing data, in accordance with an embodiment of the disclosure;

FIG. 9 illustrates another exemplary map database record storing data, in accordance with an embodiment of the disclosure; and

FIG. 10 illustrates another exemplary map database storing data, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The present invention relates to a method and a system for identifying the POI using the TSE algorithm, using a machine learning model. Trip data associated with the trips may be received from one or more vendors of the trip data. The trip data may be stored in a well-organized and efficiently indexed trip database. Accordingly, various embodiments provide the method and the system to receive information related to the trip data from probe trajectory data or probe data. The probe data may be collected from vehicles, which may provide detailed information about travel patterns and trip dynamics. In another embodiment, the probe data may be received from one or more databases associated with one or more vendors of the probe data. The received trip data may be used to determine the deceleration of the vehicle, using the TSE algorithm. Trip data may be further used to determine the probability that the trip ended at the POI using a machine learning model. This may help to extract useful information to determine whether the trip ended at the POI, or is just a continuation of the larger journey. Furthermore, trip data may be used to update trip generation forecasts in real-time, reflecting changes in travel patterns and deceleration of the vehicle.

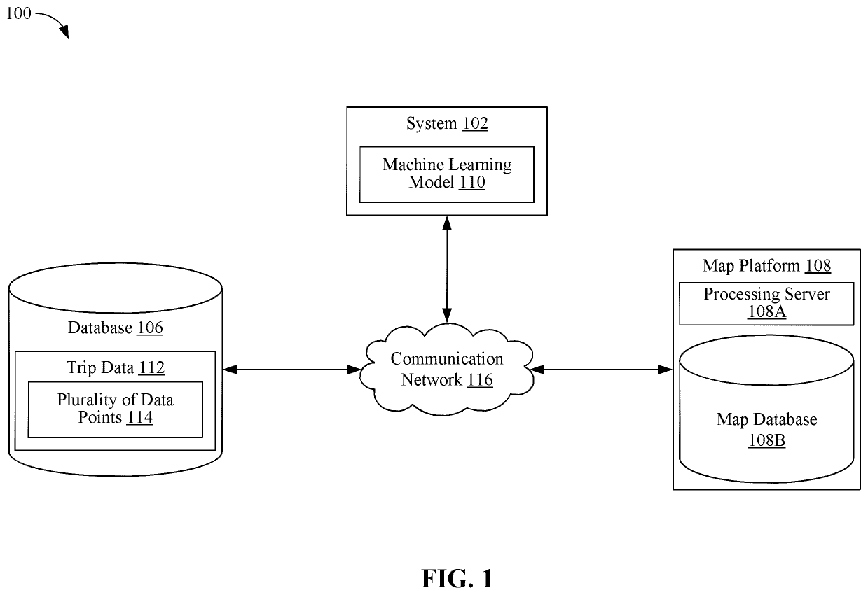

FIG. 1 illustrates a schematic diagram of a network environment 100 in which a system 102 for identifying the POI using the TSE algorithm is implemented, in accordance with an embodiment of the disclosure. The system 102 may be communicatively coupled to a database 104, and a mapping platform 108 via a communication network 106. Further, the system 102 may include a machine learning (ML) model 110. the database 104 may store trip data 112 associated with each of a plurality of data points 114 of a trip segment of a trip. The components described in the network environment 100 may be further broken down into more than one component such as one or more sensors or applications in user equipment and/or combined together in any suitable arrangement. Further, one or more components may be rearranged, changed, added, and/or removed without deviating from the scope of the present disclosure.

The system 102 may include suitable logic, circuitry, interfaces, and/or code that may be configured for identifying the POI using the TSE algorithm. In an embodiment, the system 102 may be configured to receive the trip data 112 including the plurality of data points 114. The trip data 112 includes speed data and location data. The trip data 112 may be received from the database 104 or various original equipment manufacturers (OEM). The system 102 may further determine a deceleration condition associated with a set of consecutive data points of the plurality of data points 114. The system 102 may further determine a geographical region associated with the set of consecutive data points based on the location data of each data point of the set of consecutive data points, in response to determining the deceleration condition. The system 102 may further determine the geographical region to be associated with a point of interest (POI) location. The system 102 may further determine, using the machine learning (ML) model 110, a probability value for an occurrence of a stop event of the trip based on the determined geographical region to correspond to the POI location, and store the trip data 112 in association with the stop event of the trip.

In an exemplary embodiment, the system 102 may be embodied in one or more of several ways as per the required implementation. For example, the system 102 may be embodied as a cloud-based service, a cloud-based application, a remote server-based service, a remote server-based application, a virtual computing system, a remote server platform, or a cloud-based platform.

The system 102 may further include the ML model 110. The system 102 may be further configured to determine the probability value for the occurrence of a stop event of the trip using the ML model 110. The ML model 110 may be a classification model that may be trained to identify a relationship between inputs, (such as trip data 112 in a training dataset that may include a dataset of the plurality of data points 114) and output probability value for the occurrence of a stop event. The ML model 110 may be defined by its hyper-parameters, for example, the number of weights, cost function, input size, number of layers, and the like. The hyper-parameters of the ML model 108 may be tuned and weights may be updated to move towards a global minima of a cost function for the ML model 110. After several epochs of training on the feature information in the training dataset, the neural network model may be trained to generate the ML model 110 and subsequently output a classification result for a set of inputs.

The ML model 110 may include electronic data, such as, for example, a software program, code of the software program, libraries, applications, scripts, or other logic or instructions for execution by a processing device, such as circuitry. The ML model 110 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 110 may be implemented using a combination of hardware and software. Although in FIG. 1, the ML model 110 is shown integrated within the system 102, the disclosure is not so limited. Accordingly, in some embodiments, the ML model 110 may be a separate entity in the system 102, without deviation from the scope of the disclosure. Examples of the ML model 110 may include but are not limited to, a linear regression model, a logistic regression model, a decision tree model, a random forest-based model, a support vector machines (SVM) based model, and a K-mean-based model. In an embodiment, the ML model 108 may correspond to a trained neural network model, such as, but not limited to an artificial neural network (ANN) based model, Artificial Neural Network Long Short-Term Memory network (ANN-LSTM), a fully connected neural network-based model, and/or a combination of such networks.

The database 104 may be a trip database, but in alternate embodiments, the database 106 may be embodied as a client-side map database and may represent a compiled trip data database that may be used in or with end user equipment such as a user device to provide trip data. The database 104 may be configured to store the trip data 112 over a period of time. The trip data 112 may be collected by one or more devices such as one or more sensors or image capturing devices or mobile devices. In an embodiment, the trip data 112 may also be captured from connected-car sensors, smartphones, personal navigation devices, fixed road sensors, smart-enabled commercial vehicles, and expert monitors observing accidents and construction. In an embodiment, the database 104 may be configured to store the trip data 112 including the plurality of data points 114 of a trip segment of a trip.

The mapping platform 108 may include the map database 108B for storing map data and a processing server 108A. The map database 108B may store node data, road segment data, link data, point of interest (POI) data, link identification information, heading value records, data about various geographic zones and regions, pedestrian data for different regions, heat maps, or the like. Also, the map database 108B further includes speed limit data of different lanes, cartographic data, routing data, and/or maneuvering data. Additionally, the map database 108B may be updated dynamically to accumulate real-time traffic data. The real-time traffic data may be collected by analyzing the location transmitted to the mapping platform 108 by a large number of road users through the respective user devices of the road users. In one example, by calculating the speed of the road users along a length of the road, the mapping platform 108 may generate a live traffic map, which is stored in the map database 108B in the form of real-time traffic conditions. In an embodiment, the map database 108B may store data from different zones in a region. In one embodiment, the map database 108B may further store historical traffic data that includes travel times and average speeds on each road or area at any given time of the day and any day of the year. In an embodiment, the map data in the map database 108B may be in the form of map tiles. Each map tile may denote a map tile area including a plurality of road segments or links within the map tile.

According to some example embodiments, the road segment data records may be links or segments representing roads, streets, or paths, as may be used in calculating a route or recorded route information for the determination of one or more personalized routes. The node data may be ending points corresponding to the respective links or segments of road segment data. The road link data and the node data may represent a road network used by vehicles such as cars, trucks, buses, motorcycles, and/or other entities. Optionally, the map database 108B may contain path segment and node data records, such as shape points or other data that may represent pedestrian paths, links, or areas in addition to or instead of the vehicle road record data, for example. The road/link and nodes may be associated with attributes, such as geographic coordinates, street names, address ranges, speed limits, turn restrictions at intersections, and other navigation-related attributes. The map database 108B may also store data about the POIs and their respective locations in the POI records. The map database 108B may additionally store data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 108B may include event data (e.g., traffic incidents, construction activities, scheduled events, unscheduled events, accidents, diversions, etc.) associated with the POI data records or other records of the map database 108B associated with the mapping platform 108. Optionally, the map database 108B may contain path segment records and node data records or other data that may represent pedestrian paths or areas in addition to or instead of the autonomous vehicle road record data.

As mentioned above, the map database 108B may be a master geographic database, but in alternate embodiments, the map database 108B may be embodied as a client-side map database and may represent a compiled navigation database that may be used in or with end user equipment such as the user device to provide navigation and/or map-related functions. For example, the map database 108B may be used with the user device to provide an end user with navigation features. In such a case, the map database 108B may be downloaded or stored locally (cached) on the user device.

The processing server 108A may include processing means, and communication means. For example, the processing means may include one or more processors configured to process requests received from the user device. The processing means may fetch map data from the map database 108B and transmit the same to the user device. In one or more example embodiments, the mapping platform 108 may periodically communicate with the user device via the processing server 108A to update a local cache of the map data stored on the user device. Accordingly, in some example embodiments, the map data may also be stored on the user device and may be updated based on periodic communication with the mapping platform 108.

In some example embodiments, the user device (not shown) may be any user accessible device such as a mobile phone, a smartphone, a portable computer, and the like, as a part of another portable/mobile object such as a vehicle. The user device may include a processor, a memory, and a communication interface. The processor, the memory, and the communication interface may be communicatively coupled to each other. In some example embodiments, the user device may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation-related functions to the user. In such example embodiments, the user device may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user device. Additional, different, or fewer components may be provided. In one embodiment, the user device may be directly or indirectly coupled to the system 102 via the communication network 106. For example, the user device may be a dedicated vehicle (or a part thereof) for gathering data for the development of the map data in the map database 108B. In some example embodiments, the user device may serve the dual purpose of a data gatherer and a beneficiary device. The user device may be configured to capture sensor data associated with a road that the user device may be traversing. The sensor data may for example be image data of road objects, road signs, or the surroundings. The sensor data may refer to sensor data collected from a sensor unit in the user device.

The communication network 106 may be wired, wireless, or any combination of wired and wireless communication networks, such as cellular, Wi-Fi, internet, local area networks, or the like. In one embodiment, the communication network 106 may include one or more networks such as a data network, a wireless network, a telephone network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. For example, the mapping platform 108 may be integrated into a single platform to provide a suite of mapping and navigation-related applications for OEM devices, such as the user devices and the system 102. The system 102 may be configured to communicate with the mapping platform 108 over the communication network 106.

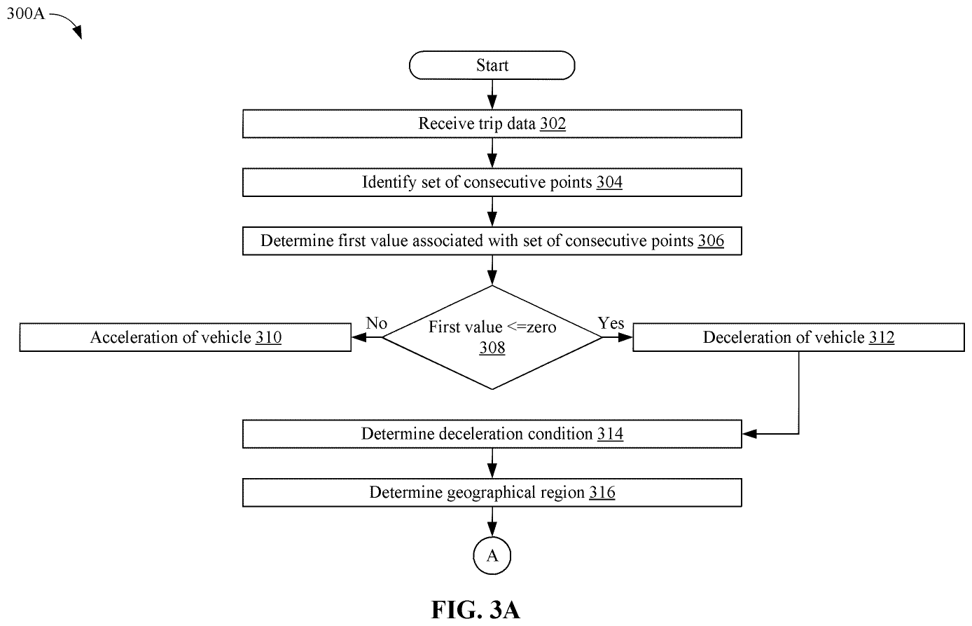

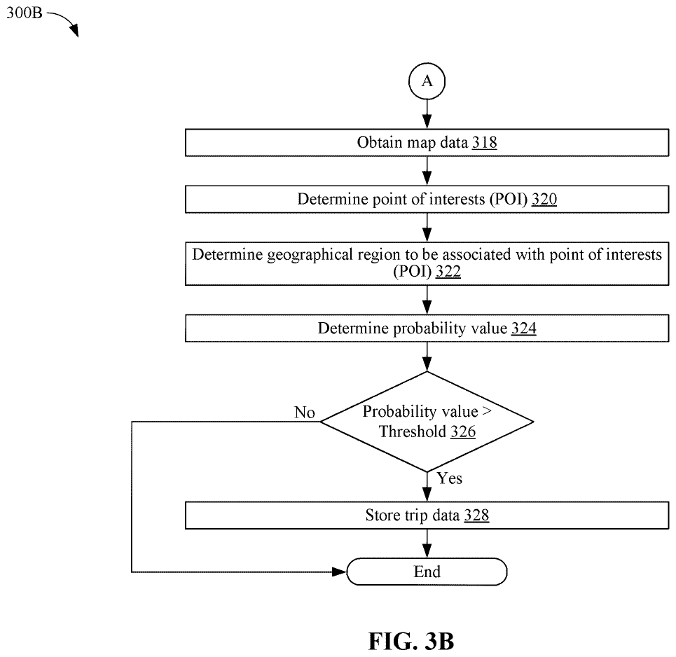

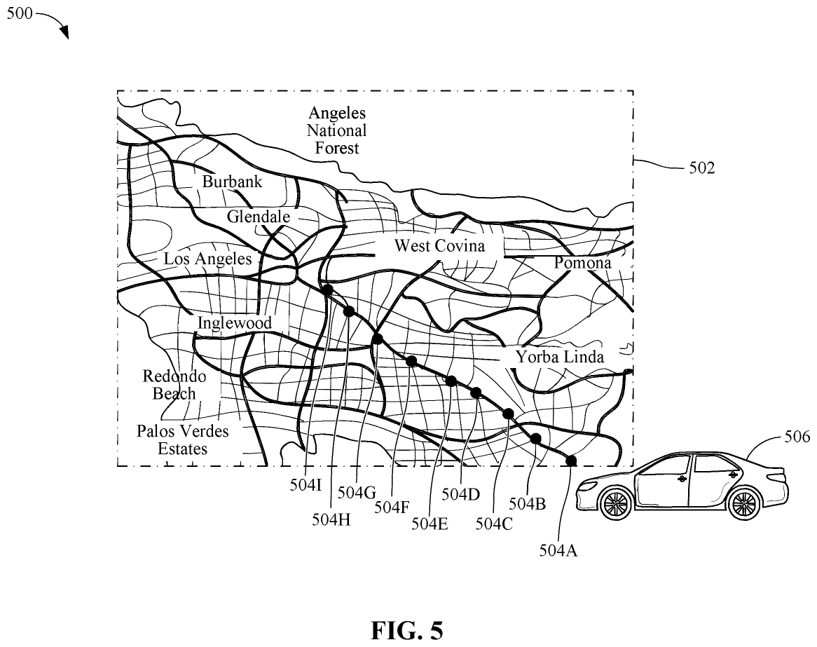

In operation, the system 102 is configured to receive the trip data 112. The trip data 112 may include the plurality of data points 114 of the trip segment of the trip. The trip data 112 includes speed data and location data. In an embodiment, the trip data 112 may be stored in the database 104. Details about the received trip data 112 are provided, for example, in FIG. 3A and FIG. 5.

In an embodiment, the system 102 is configured to determine a deceleration condition associated with a set of consecutive data points of the plurality of data points 114. The set of consecutive data points terminates at an end point of the plurality of data points 114. Further, in response to determining the deceleration condition, the system 102 may be configured to determine a geographical region associated with the set of consecutive data points based on the location data of each data point of the set of consecutive data points. Details associated with the determined deceleration condition are provided, for example, in FIG. 3A.

In an embodiment, the system 102 is configured to determine the geographical region to be associated with a point of interest (POI) location. The system 102 may be further configured to determine, using a machine learning (ML) model 110, a probability value for the occurrence of a stop event of the trip based on the determined geographical region to correspond to the POI location. Furthermore, based on the determination of the probability value to be greater than a threshold value, the system 102 may be configured to store the trip data in association with the stop event of the trip. Details associated with the determination of the probability value are provided, for example, in FIG. 3B.

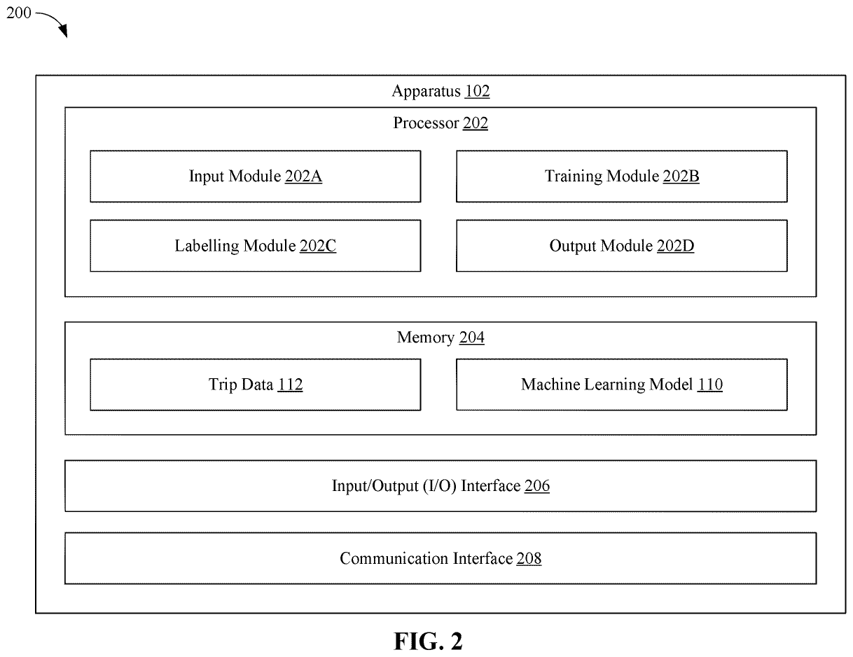

FIG. 2 illustrates a block diagram of the system of FIG. 1, in accordance with an embodiment of the disclosure. The system 102 may include at least one processor 202 (hereinafter, also referred to as “processor 202”), at least one memory 204 (hereinafter, also referred to as “memory 204”), I/O interface 206 (hereinafter, also referred to as “I/O interface 206”), and communication interface 208 (hereinafter, also referred to as “communication interface 208”). The processor 202 may include an input module 202A, a machine learning application module 202B, a deceleration condition determination module 202C, and an output module 202D. The processor 202 may retrieve computer program code instructions that may be stored in the memory 204 for execution of the computer program code instructions. The memory 204 may store data including the trip data 112, and the ML model 110.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of computer program code instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as the network environment 100 may be accessed using the communication interface 208 of the system 102. The communication interface 208 may provide an interface for accessing various features and data stored in the system 102.

In an embodiment, the input module 202A of the processor 202 may receive trip data 112 including the plurality of data points 114 The input module 202A may receive the trip data 112 from one or more sensors including but not limited to acoustic sensors such as a microphone array, position sensors such as a GPS sensor, a gyroscope, motion sensors such as accelerometer, an image sensor such as a camera and the like. The trip data 112 may include speed data and location data. The trip data 112 further includes lane information of a vehicle associated with each of a plurality of data points and orientation information of the vehicle associated with each of a plurality of data points. The received trip data 112 from the trips may provide a relevant aspect of the trips to be used in a plurality of aspects such as route recommendations, improved estimation of arrival times, optimized routes for navigation, multi-modal transportation, or the like. The trip data 112 extracted from trips may be used in product use cases. The extracted trip data may be defined, generated, and stored in a manner that the privacy of the user may be protected. The user may be associated with the trip from where the trip data 112 is received. The system 102 may be accessed using the communication interface 208. The communication interface 208 may provide an interface for accessing various features and data stored in the system 102.

Furthermore, in another embodiment, the input module 202A of the processor 202 may further be configured to execute the computer program code instructions which may be configured to cause the system 102 to receive the trip data 112 including the plurality of data points 114. In an example, the system 102 may output the probability value for the occurrence of a stop event of the trip based on the trip data 112, via a user interface.

The training module 202B of the processor 202 may be configured to train the ML model 110 to generate the probability value. In an embodiment, the training module 202B of the processor 202 may be configured to re-train the ML model 110 in certain iterations to improve accuracy of the generated probability value. In an embodiment, the training module 202B trains the ML model 110 to employ ML algorithms and techniques to analyze the trip data 112 associated with each datapoint of the plurality of datapoints 114, and further generate the probability value based on the analysis.

The labelling module 202C of the processor 202 may be configured to associate each stop event of the one or more stop events with a type of event label. In particular, the labelling module 202C may be configured to determine whether the reference location associated with a stop event of the one or more stop events corresponds to the signalized intersections, the non-signalized intersection, the road segment, or the POI. Further, the labelling module 202C may be configured to associate the stop event with the type of event label based on the determination that the reference location of the stop event corresponds to one of the signalized intersections, the non-signalized intersection, or the road segment between road segments.

The output module 202D may be configured to output the probability value for the occurrence of a stop event of the trip. In an embodiment, the system 102 may be configured to output the probability value for the occurrence of the stop event of the trip of the vehicle. For example, the trip data 112 may include the speed data and location data to determine the deceleration of the vehicle in the vicinity of the POI. In an embodiment, in response to the deceleration of the vehicle near the POI, the system 102 may be configured to leverage the use of ML model 110 to determine whether that trip ended at the POI or is just a continuation of the larger journey. The trip data 112 may also include tile level data obtained from the map database 108B.

The memory 204 of the system 102 may be configured to store the trip data 112, the ML model 110. The trip data 112 may include speed data, location data, lane information of the vehicle associated with each of a plurality of data points, and orientation information of the vehicle associated with each of a plurality of data points. In an example, the trip data 112 at least one of a trip origin timestamp, a trip transportation mode, a trip origin city, a trip travel time of the vehicle, a trip tile ID associated with the origin and destination of the trip, a trip start latitude, a trip start longitude, a trip end latitude, a trip end longitude, a trip probe frequency of the probe, a trip dwell count of the vehicle, a trip probe data type. The memory 204 may be non-transitory and may include, for example, one or more volatile and/or non-volatile memories. In other words, for example, the memory 204 may be an electronic storage device (for example, a computer readable storage medium) including gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure.

For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may be configured to receive the input and/or output generated by the system 102. In an embodiment, the I/O interface 206 may be configured to communicate with the system 102 and display the input and/or output of the system 102. As such, the I/O interface 206 (for example, an infotainment system) may include a display screen and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display device and, in some embodiments, a plurality of speakers, a ringer, one or more microphones and/or the like. In an embodiment, the I/O interface 206 may include an input interface and output interface for supporting communications to and from the system 102 or any other component with which the system 102 may communicate. The processor 202 may be configured to control one or more functions of one or more I/O interface 206 elements through computer program instructions (for example, software and/or firmware) stored on the memory 204 accessible to the processor 202. The processor 202 may further render the first trip data associated with the identified first trip of the vehicle 104 via the user interface or the I/O interface.

The communication interface 208 may be any means such as a device or circuitry embodied in either hardware or a combination of hardware and software that is configured to receive and/or transmit data to/from other communication devices in communication with the system 102. In this regard, the communication interface 208 may include, for example, one or more antennas and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication port, a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning.

In an embodiment, the system 102 may be configured to receive the trip data associated with each of a plurality of data points of a trip segment of a trip. In an embodiment, the deceleration condition associated with a set of consecutive data points of the plurality of data points may be determined. Further, based the determined deceleration condition, the system 102 may be configured to determine a geographical region associated with the set of consecutive data points based on the location data of each data point of the set of consecutive data points. In an exemplary embodiment, the geographical region may be associated with a point of interest (POI) location. The system 102 may be configured to determine the probability value for occurrence of the stop event of the trip based on the determined geographical region to correspond to the POI location.

Further, in another embodiment, the trip data 112 may be stored by the map database 108B of the mapping platform 108. The mapping platform 108 may use the trip data to enhance traffic analytics by exploring various applications such as origin-destination (OD) estimation, route recommendations, improved estimated times of arrival (ETAs), venue analytics, optimized routing for electric vehicles (EVs), and multi-modal transportation.

In an embodiment, the system 102 may output the trip data to the mapping platform 108 via the communication network 110. To that end, the system 102 may be communicatively coupled to the database 104 and the mapping platform 108 via the communication network 110.

FIG. 3A and FIG. 3B jointly illustrate a flowchart of a method for determining a probability value for an occurrence of a stop event, in accordance with an embodiment of the disclosure. FIG. 3A and FIG. 3B are explained in conjunction with elements from FIG. 1, and FIG. 2. With reference to FIG. 3A and FIG. 3B, there is shown the block diagram 300 that illustrates exemplary operations from 302 to 328, as described herein. The exemplary operations illustrated in the block diagram 300 may be performed by any computing system, apparatus, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the implementation.

At 302, the trip data 112 may be received. In an embodiment, the processor 202 may be configured to receive the trip data 112 associated with each of the plurality of data points 114 of a trip segment of a trip. The trip refers to a trip of a vehicle from one location to another (such as from an origin to a destination). For example, a user of the vehicle may take an origin-destination (OD) trip for various purposes, such as leisure, business, personal reasons, and the like. For example, the OD trip may include multiple destinations or activities. In such an example, the trip may be divided into multiple trip segments, where each trip segment may correspond to a short trip. Further, the trip segment may be associated with a trip identifier. For example, each segment has its unique trip identifier. Such trip identifiers may be truncated to provide anonymity and protect user privacy. For example, the OD trip may be divided into multiple trip segments, and each of the trip segments may be associated with a trip identifier. This may imply that there may be multiple trip identifiers for a single OD trip. For example, the OD trip may include 5 trip segments corresponding to Trip ID 1, trip ID 2, trip ID 3, trip ID 4, and Trip ID 5.

Further, each trip segment may include the plurality of data points 114 such as but not limited to a first data point, a second data point, a third data point, and an Nth data point. Each data point is a record of a specific location of the vehicle at a specific timestamp. The data point may include the specific time stamp, and a set of geographical coordinates (latitude and longitude) associated with the vehicle. The data point may include the speed of the vehicle, and a heading value associated with the vehicle. The speed of the vehicle may correspond to the velocity of the vehicle at that specific point in time. The heading value may be indicative of a direction in which the vehicle may be moving and is typically measured in degrees relative to true north (0° to 360°).

In an embodiment, the trip data 112 may be associated with the trip of the vehicle. The vehicle may be a non-autonomous vehicle, a semi-autonomous vehicle, or a fully autonomous vehicle, for example, as defined by the National Highway Traffic Safety Administration (NHTSA). Examples of the vehicle may include but are not limited to, a two-wheeler electric vehicle, a three-wheeler electric vehicle, a four-wheeler electric vehicle, or more than a four-wheeler electric vehicle. Examples of two-wheeler vehicles may include, but are not limited to, an electric two-wheeler, or a hybrid two-wheeler. Similarly, examples of the four-wheeler vehicle may include, but are not limited to, an electric car, or a hybrid car. The present disclosure may also apply to other structures, designs, or shapes of the vehicle. The description of other types of vehicles and respective structures, designs, or shapes has been omitted from the disclosure for the sake of brevity.

In some example embodiments, the vehicle may include processing means such as a central processing unit (CPU), storage means such as on-board read-only memory (ROM), and random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the vehicle. In some example embodiments, one or more user equipment may be associated, coupled, or otherwise integrated with the vehicle, such as an advanced driver assistance system (ADAS), a personal navigation device (PND), a portable navigation device, and/or other devices that may be configured to provide route guidance and navigation-related functions to a user.

The trip data 112 includes speed data and location data. The speed data may correspond to information associated with the speed of the vehicle for the corresponding trip segment. The location data may correspond to information associated with the geographical region associated with the vehicle for the corresponding trip segment. For example, the received trip data 112 associated with each of the plurality of data points 114 may include speed values for the vehicle at the corresponding data point, the location data of the vehicle at the corresponding data point, and the timestamp associated with the corresponding datapoint. The timestamp associated with the corresponding datapoint may indicate a specific time at which the trip data 112 may be collected or recorded at the location specified in the location data. The timestamp may provide temporal context to the data associated with the datapoint, allowing for analysis of traffic conditions, and speed variations over time.

At 304, the set of consecutive data points may be identified. In an embodiment, the processor 202 may be configured to identify the set of consecutive data points. The set of consecutive data points may correspond to sequential data points associated with at least one of the start of the trip or the end of the trip. Further, the set of consecutive data points includes a pre-defined number of consecutive data points of the plurality of data points 114. Such a pre-defined number may be defined by the service provider (or OEMs). For example, of the pre-defined number of consecutive data points of the plurality of data points 114 may include but not be limited to numeric values, such as 5, 8, 10, 15, and the like.

At 306, a first value may be determined. In an embodiment, the processor 202 may be configured to determine the first value associated with the set of consecutive data points based on the speed data associated with each data point of the set of consecutive data points. The first value indicates one of the acceleration of the vehicle or the deceleration of the vehicle. For example, the set of consecutive data points may correspond to sequential data points associated with an origin or start of the trip segment. The start of the trip segment may indicate the acceleration of the vehicle, where the speed value of the vehicle may increase from zero. Alternatively, the set of consecutive data points may correspond to sequential data points associated with a destination or end of the trip segment. The end of the trip segment may indicate the deceleration of the vehicle, where the speed value of the vehicle may approach zero. For example, the set of consecutive data points includes 10 consecutive data points of the plurality of data points 114 sampled over a time period of 3 minutes. Given, that the set of consecutive data points may correspond to 10 sequential data points associated with the destination or end of the trip segment, such as D1, D2, D3, . . . , D10. Each data point may include a speed value of the vehicle for the corresponding data points. For example, the first value may be calculated using the following equation:

First value=(10*SSD+100)/(SS+10)

Here, SSD refers to the sum of speed differences, and SS refers to the sum of speed metrics.

The SS may be calculated based on a summation of all the speed values from D1, D2, D3, . . . , and D10, and SSD may be calculated based on a summation of the difference of every two consecutive speed values. Thereafter, the first value may be calculated. For example, the first value may correspond to a numeric value between a range of −10 to +10.

At 308, determine whether the first value is less than or equal to zero. In an embodiment, the processor may be configured to compare the determined first value with the zero value. For example, when the first value is greater than zero, the control may pass to 310. On the contrary, when the first value is less than or equal to zero, the control may pass to 312.

At 310, the acceleration of the vehicle may be determined. In an embodiment, the processor 202 may be configured to determine the acceleration of the vehicle based on the determination of the first value greater than zero. This may indicate that the vehicle has started moving from the origin point.

At 312, the deceleration of the vehicle may be determined. In an embodiment, the processor 202 may be configured to determine the deceleration of the vehicle based on the determination that the first value is less than zero. This may indicate that the vehicle is decelerating at the end point and is about to stop. In an example, the processor 202 may be configured to determine the deceleration of the vehicle based on the determination that the first value is equal to zero. This may indicate that the vehicle has stopped at the end point and a stop event is determined.

At 314, a deceleration condition may be determined. In an embodiment, the processor 202 may be configured to determine the deceleration condition associated with a set of consecutive data points of the plurality of data points 114. The set of consecutive data points terminates at an endpoint of the plurality of data points 114. Further, the deceleration condition is associated with the deceleration of the vehicle. The deceleration condition may refer to a set of specifications indicative of the decrease in speed values of the vehicle over time. For example, a user applies a brake, thereby reducing the speed values of the vehicle until it stops or reaches a slower speed.

At 316, a geographical region may be determined. In an embodiment, in response to determining the deceleration condition, the processor 202 may be configured to determine the geographical region associated with the set of consecutive data points based on the location data of each data point of the set of consecutive data points. The geographical region may refer to a set of geographical coordinates (latitude and longitude) associated with the vehicle when the vehicle is in the deceleration condition.

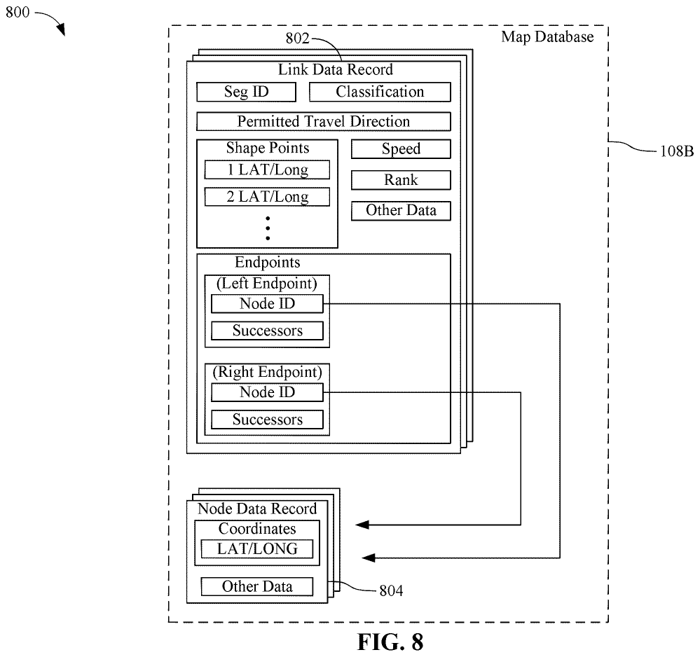

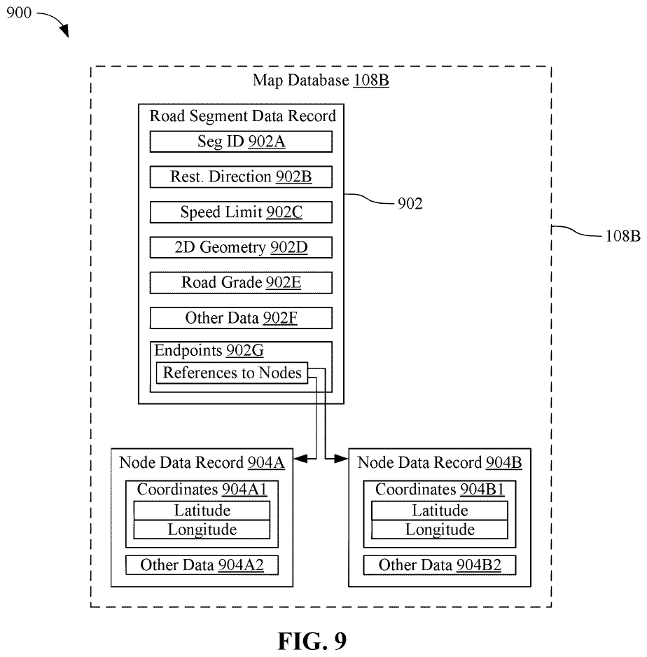

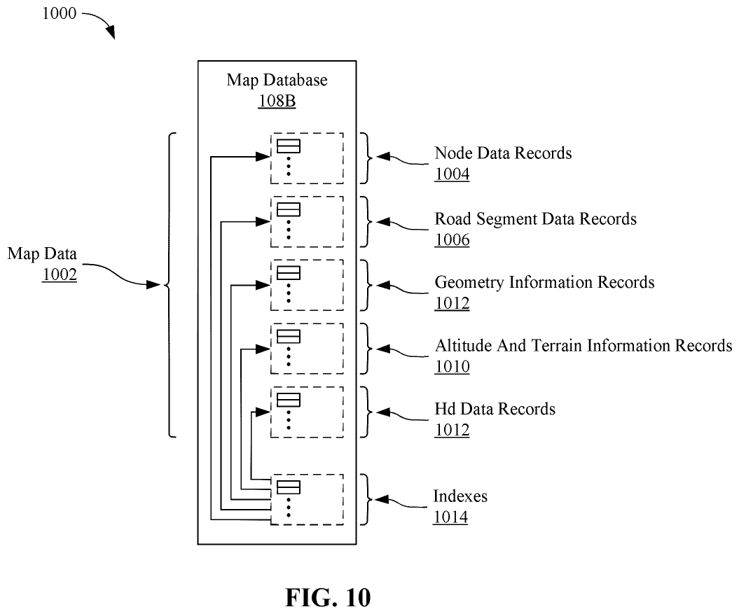

At 318, map data may be obtained. In an embodiment, the processor 202 may be configured to obtain map data. The map data may include the geographical region associated with the set of consecutive data points. For example, the map data may include information associated with a plurality of POI locations. In an embodiment, the system 102 may be configured to obtain the map data from the map database 108B. The details about the map database 108B are provided in conjunction with, for example, FIG. 1, FIG. 8, FIG. 9, and FIG. 10. In one exemplary embodiment, the map data may be retrieved from a source other than the map database 108B. In an example, the information associated with the geographical region may include a latitude and a longitude position (e.g. 39.° N, 77° W) of each POI location of the plurality of POI locations within the geographical region. Similarly, each POI location of the plurality of POI locations may be associated with the corresponding information, such as type (e.g., office building, museum, restaurant, hotel, school, etc.), operating hours, etc. In addition to the latitude and longitude position, the information may also include information indicative of a location associated with the latitude and longitude position. For example, the latitude and longitude position as “39.° N, 77° W” may be associated with a location indicative of “Washington, D.C”. In one embodiment, latitude and longitude positions may be associated with their respective locations based on map-matching techniques, thereby forming the information associated with the plurality of POI locations within the geographical region.

The map matching techniques may include but are not limited to, a geometric analysis, a hidden Markov model, a topological relationship, a fuzzy logic model, D-S evidence theory, and a Bayesian inference. The map matching techniques may align a sequence of GPS co-ordinates (e.g. the latitude and longitude positions) with a corresponding road network. The goal of the map matching techniques is to reconstruct and smooth the trajectory by matching each GPS co-ordinate to the closest road segment on a digital road network.

At 320, the POI location may be determined. In an embodiment, the processor 202 may be configured to determine the POI location based on the obtained map data. The POI location may include a latitude and longitude position, and a corresponding location associated with the latitude and longitude position. For example, based on a latitude and longitude position, ‘32° 08′59.96° N, 110° 50′09.03° W’, of the center location data, a corresponding location, for example, ‘Tucson, Arizona, United States of America (USA)’, is associated. Further, the information retrieved from the map data also includes a latitude and a longitude position and a corresponding location associated with each POI location of the plurality of POI locations. Further, to associate the determined geographical region with each of the plurality of POI locations, the system 102 may be configured to compare the determined geographical region with each of the plurality of POI locations in the map data. For example, considering the location is matched to a location of a POI in the map data based on the comparison, the system 102 may be configured to associate the determined geographical region with each of the plurality of POI locations.

At 322, a geographical region may be determined. In an embodiment, the processor 202 may be configured to determine the geographical region to be associated with a point of interest (POI) location. Further, on determining the geographical region to be associated with the POI location, the processor 202 may be configured to determine a time period associated with the stop event of the vehicle within the vicinity of the POI location. The time period associated with the stop event of the vehicle may be determined using the timestamp data of each data point of the set of consecutive data points. The time period may correspond to a numeric value for example, such as, but not limited to 2 minutes, 8 minutes, 15 minutes, 21 minutes, 24 minutes, and the like.

Thereafter, the processor 202 may be configured to compare the time period of the stop event with a time threshold. The time threshold may correspond to a numeric value for example, such as, but not limited to 15 minutes. Based on the comparison, the processor 202 may be configured to determine the POI location to be associated with a parking area. For example, in response to the determination of the time period of the stop event greater than or equal to the time threshold, then the processor 202 may be configured to determine the POI location to be associated with the parking area. Alternatively, in response to the determination of the time period of the stop event less than the time threshold, then the processor 202 may be configured to determine the POI location to be associated with a normal halt in the trip rather that the parking or the stop event.

At 324, a probability value may be determined. In an embodiment, the processor 202 may be configured to determine, using the machine learning (ML) model 110, the probability value for the occurrence of the stop event of the trip based on the determined geographical region to correspond to the POI location. The probability value may indicate a likelihood that the vehicle made a stop at the POI location for the corresponding trip segment.

At 326, the probability value may be compared with a threshold value. In an embodiment, the processor 202 may be configured to compare the probability value with the threshold value to determine whether the trip ended at the POI location or is just a continuation of the larger journey. For example, if the probability value is greater than the threshold value, the control may pass to 328. On the contrary, if the probability value is less than the threshold value, the control may pass to the end.

At 328, the trip data 112 in association with the stop event of the trip may be stored. In an embodiment, the processor 202 may be configured to store the trip data 112 in association with the stop event of the trip based on the determination of the probability value to be greater than the threshold value. In an example, the trip data 112 may be stored in the database 106.

In an embodiment, the trip data 112 may include lane information of the vehicle associated with each of the plurality of data points 114, and orientation information of the vehicle associated with each of the plurality of data points 114. The lane information of the vehicle associated with each of the plurality of data points 114 may correspond to information associated with lane change by the user of the vehicle. For example, the vehicle may deviate from the road lanes towards the edge of the road or a designated parking area. The processor 202 may be configured to perform lane-level map-matching using the map database 108B, to determine if the vehicle is parked in the designated parking area or not.

Further, the orientation information of the vehicle associated with each of the plurality of data points 114 may correspond to information associated with the change of the heading degree of the vehicle indicative of a direction in which the vehicle 104 may be moving and is typically measured in degrees relative to true north (0° to 360°). The processor 202 may be configured to determine the heading degree associated with the orientation information of the vehicle with a threshold degree. For example, when the heading degree associated with the orientation information of the vehicle is greater than the threshold degree (such as 30 degrees), the processor 202 may determine that the vehicle is parked near the POI location.

In an embodiment, the processor 202 may be configured to determine, using the ML model 110, the probability value for the occurrence of the stop event based on the lane information of the vehicle associated with each of the set of consecutive data points 114, and the orientation information of the vehicle associated with each of the set of consecutive data points 114. For example, if the first value indicates that the trip has ended near the POI location, and there may be a change of the trip identifier near the POI location, then the processor 202 may be configured to determine whether the trip ended at the POI location or is just a continuation of the larger journey. To determine the trip end, the trip data 112 may be analyzed, and based on the analysis the ML model 110 may determine the probability value for the occurrence of the stop event of the trip.

In an embodiment, the processor 202 may be configured to train the ML model 110 on historical data associated with one or more vehicles to determine the probability value for the occurrence of the stop event of the trip. The historical data associated with the POI location may correspond to past trip data associated with the POI location. The historical data associated with one or more vehicles may include speed data associated with each of the historical trips, location data associated with each of the historical trips, timestamp information associated with each of the historical trips, parking information associated with each of the historical trips, orientation information associated with the each of the historical trips, vehicle data associated with the vehicle, or a combination thereof.

In an embodiment, the processor 202 may be configured to receive the historical data associated with the POI location. Further, the processor 202 may be configured to determine vehicle data associated with the POI location based on historical data. The vehicle data is associated with one or more parked vehicles within a threshold distance from the POI location. For example, the vehicle data may indicate a number of vehicles parked at a particular parking area within the vicinity of the POI location in past days. For example, 12 cars may have been parked at the paring location in the past 3 days. Further, the vehicle data may include, for example, but is not limited to, the health status of the vehicle and one or more parameters associated with one or more electronic devices associated with the vehicle. The one or more electronic devices associated with the vehicle may include but are not limited to, a Heating, Ventilation, and Air Conditioning system, an infotainment system, an on-board diagnostics system, a Tire Pressure Monitoring System, a Battery Management System, a vehicle control unit, a navigation system, and an Advanced Driver Assistance System.

Further, the processor 202 may be configured to determine, using the ML model 110, the probability value associated with the occurrence of the stop event of the trip based on the vehicle data. This may facilitate the system 102 to determine whether the vehicle is parked in association with the parking area associated with the POI location or is just an accidental stop. Therefore, the system 102 may be configured to determine the end of the trip at the POI location using the ML model 110.

In an embodiment, the processor 202 may be configured to associate each stop event with a label including the trip label based on the corresponding POI location. In an embodiment, the processor 202 may be configured to determine POI information from map database 108B. Further, the processor 202 may be configured to generate, using the ML model 110, a label corresponding to the trip segment. The label may indicate the POI information corresponding to the stop event. Thereafter, the processor 202 may be configured to store the trip data in association with the label. For example, if the trip ended at a mall, then the processor 202 may be configured to generate the label as a shopping trip. Similarly, if the trip ends near a coffee shop then the processor 202 may be configured to generate the label a coffee trip.

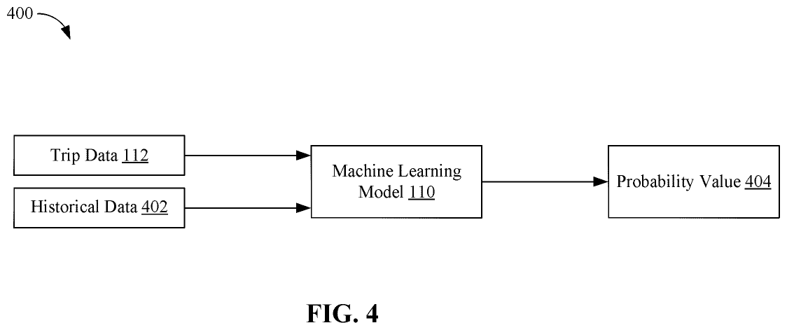

FIG. 4 illustrates exemplary operations for determining the probability value for the occurrence of the stop event of the trip using the machine learning model, in accordance with an embodiment of the disclosure. FIG. 4 is explained in conjunction with elements from FIG. 1, FIG. 2, FIG. 3A, and FIG. 3B. With reference to FIG. 4, there is shown the block diagram 400 that illustrates exemplary operations from 402 to 414, as described herein. The exemplary operations illustrated in the block diagram 400 may be performed by any computing system, apparatus, or device, such as by the system 102 of FIG. 1 or the processor 202 of FIG. 2. Although illustrated with discrete blocks, the exemplary operations associated with one or more blocks of the block diagram 400 may be divided into additional blocks, combined into fewer blocks, or eliminated, depending on the implementation.

In an embodiment, the processor 202 may be configured to re-train the ML model 110 based on the trip data 112, and the historical data 402 associated with the POI location and store the re-trained ML model 110. For example, the ML model 110 may receive the trip data 112, and the historical data 402 as an input, and generate the probability value 404 as an output based on the received input. For example, the stop event occurs near a coffee shop or within the vicinity of the coffee shop, where the coffee shop is the POI location. The ML model 110 may be trained to determine the probability value associated with the stop event and generate the label for the trip based on the trip data 112, and the historical data 402. Further, if the stop event occurs near more than one POI location, then the ML model 110 may be configured to determine the probability value for each of the POI locations being visited individually, based on the trip data 112, and the historical data 402.

FIG. 5 illustrates a schematic diagram depicting a plurality of data points of a trip segment of a trip, in accordance with an embodiment of the disclosure. FIG. 5 is explained in conjunction with elements from FIG. 1, FIG. 2, FIG. 3, and FIG. 4. With reference to FIG. 5, there is shown an exemplary diagram 500 depicting route 500 associated with the trip of the vehicle upon the map interface 502. The route 500 may be considered as a journey that includes one or more data points for example, but not limited to 504A, 504B, 504C, 504D, 504E, 504F, 504G, 504H, 504I, and 504J. The processor 202 may be configured to receive the trip data 112 associated with each of the plurality of data points of a trip segment of the trip.

In an exemplary embodiment, the first data point 504A may be associated with the trip data 112 indicative of a starting point of the OD trip. The first data point 504A may mark the beginning of a travel path of the trip. The travel path may be included in the trip data 112. For example, a vehicle 506 travels between the first data point 504A and the second data point 504B, and the deceleration of the vehicle 506 occurs at the second data point 504B. Further, the system 102 may determine a stop event of the vehicle within the vicinity of the POI location at the second data point 504B, for example, such as for 15 minutes, if the time period of the stop event is greater than or equal to a time threshold, then determine the POI location to be associated with the parking area. In such an example, the first data point 504A and the second data point 504B may be considered as the trip segment and stored in the database 106. Thereafter, in response to the determining the deceleration of the vehicle near the POI, and change of the trip identifier, the probability value for the occurrence of the stop event of the trip may be determined using the ML model 110, to determine whether the trip ended at the POI, or is a continuation of the larger journey.

In an exemplary embodiment, the vehicle 506 travels between second data point 504B and a third data point 504C, and the deceleration of the vehicle occurs at the third probe point 504C. Further, the system 102 may determine a stop event of the vehicle 506 within geographical region associated with the POI at the third data point 504C, for example, such as for 5 minutes, if the time period of the stop event is less than the time threshold to then the POI location may not be associated with the parking area. In such an example, the second data point 504B and the third data point 504C may not be considered as the trip segment.

In an exemplary embodiment, the vehicle 506 travels between third data point 504C and a fourth data point 504D, and the deceleration of the vehicle occurs at the fourth data point 504D. Further, the system 102 may determine a stop event of the vehicle 506 within geographical region not associated with the POI location at the fourth data point 504D. In such an example, the third data point 504C and the fourth data point 504D may not be considered as the trip segment.

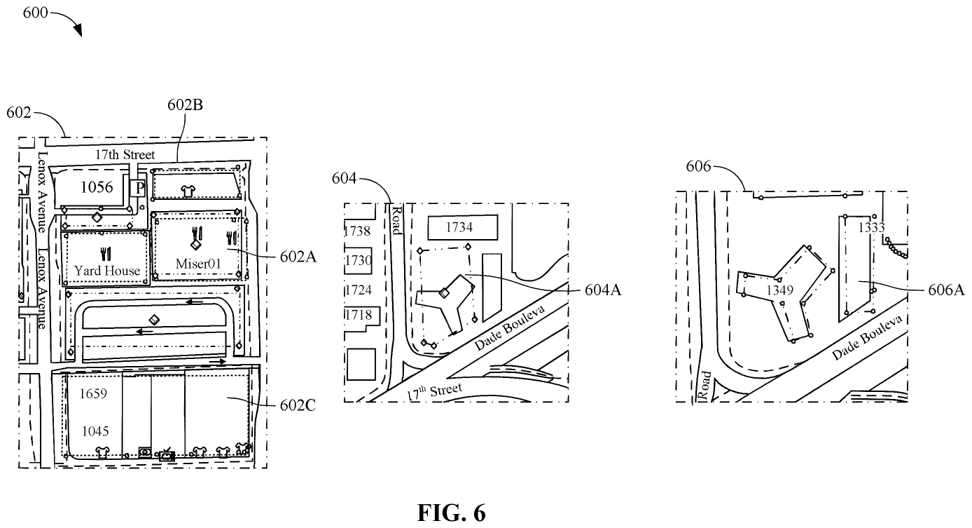

FIG. 6 illustrates a schematic diagram of an exemplary POI, and a footprint associated therewith, in accordance with an embodiment of the disclosure. FIG. 6 is explained in conjunction with elements from FIG. 1, FIG. 2, FIG. 3A, FIG. 3B, FIG. 4 and FIG. 5. With reference to FIG. 6, there is shown the schematic diagram 600 of the geographical regions associated with the POI location. There is shown a first geographical region 602, a second geographical region 604, and a third geographical region 606. Each geographical region includes one or more POI locations associated therewith.

For example, the first geographical region 602 includes the one or more POI locations 602A, 602B, and 602C. The POI location 602A may correspond to a restaurant, the POI location 602B may correspond to a shopping center, and the POI location 602C may correspond to a commercial mall. Further, the second geographical location 604 may include a POI location 604A which may be a coffee place, and the third geographical location 606 may include a POI location 606A that may be a gaming zone. For example, the system 102 may leverage the use of a bounding box around the POI location for geospatial analysis, thereby focusing on a specific location within a larger geographical region for detailed analysis or highlighting the POI location on a map.

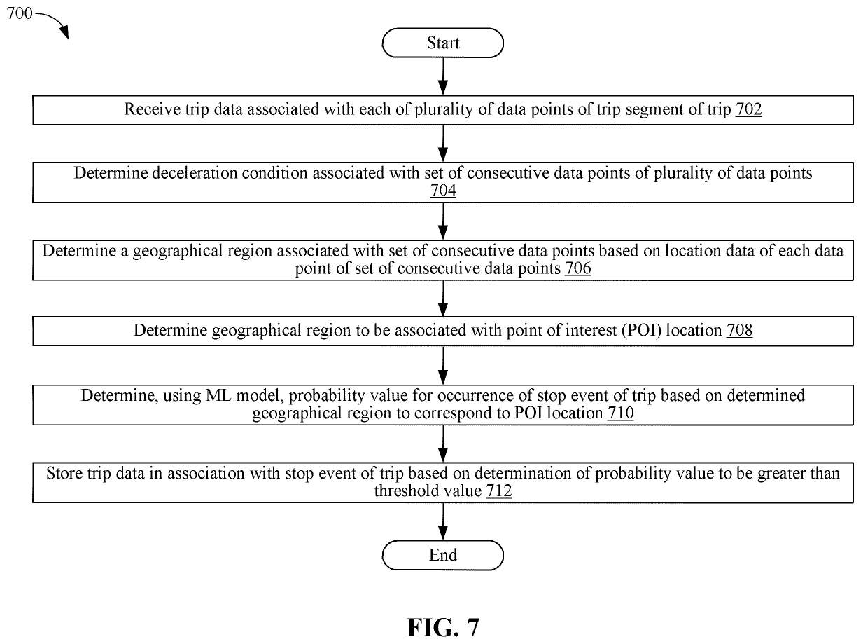

FIG. 7 illustrates a flowchart of a method for identifying the POI using the TSE algorithm, in accordance with an embodiment of the disclosure. FIG. 7 is explained in conjunction with elements from FIG. 1, FIG. 2, FIG. 3A, FIG. 3B, FIG. 4, FIG. 5, and FIG. 6. It will be understood that each block of the flow diagram of the flowchart 700 may be implemented by various means, such as hardware, firmware, processor, circuitry, and/or other communication devices associated with execution of software including one or more computer program instructions. For example, one or more of the procedures previously stated may be embodied by computer program instructions. In this regard, the computer program instructions that embody the procedures previously stated may be stored by a memory 204 of the system 102, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special-purpose hardware-based computer systems that perform the specified functions, or combinations of special-purpose hardware and computer instructions. The flowchart 700 illustrated by the flowchart diagram of FIG. 7 is a flow chart for utilizing probe data to identify a trip of vehicle which may improve traffic analytics. Fewer, more, or different steps may be provided.

At 702, the trip data 112 may be received. In an embodiment, the system 102 may be configured to receive the trip data 112 associated with each of the plurality of data points 114 of a trip segment of a trip. The trip data 112 includes speed data and location data. In an example, the trip data 112 further includes lane information of the vehicle associated with each of a plurality of data points and orientation information of the vehicle associated with each of a plurality of data points. Details about receiving the trip data 112 are provided, for example, in FIG. 3A.

At 704, the declaration condition may be determined. In an embodiment, the system 102 may be configured to determine the deceleration condition associated with the set of consecutive data points of the plurality of data points 114. The set of consecutive data points terminates at an endpoint of the plurality of data points 114. Details about determining the deceleration conditions are provided, for example, in FIG. 3A.

At 706, the geographical region may be determined. In an embodiment, the system 102 may be configured to determine a geographical region associated with the set of consecutive data points based on the location data of each data point of the set of consecutive data points, in response to determining the deceleration condition. Details about determining the geographical region are provided, for example, in FIG. 3A.

At 708, the geographical region to be associated with a point of interest (POI) location may be determined. In an embodiment, the system 102 may be configured to determine the geographical region to be associated with a point of interest (POI) location. Details about determining the POI are provided, for example, in FIG. 3B.

At 710, the probability value may be determined. In an embodiment, the system 102 may be configured to determine, using a machine learning (ML) model 110, a probability value for occurrence of a stop event of the trip based on the determined geographical region to correspond to the POI location. Details about ML model 110 are provided, for example, in FIG. 3B, and FIG. 4.

At 712, the trip data 112 may be stored. In an embodiment, the system 102 may be configured to store the trip data 112 in association with the stop event of the trip based on the determination of the probability value to be greater than a threshold value.

Accordingly, blocks of the flowchart 700 support combinations of means for performing the specified functions and combinations of operations for performing the specified functions. It will also be understood that one or more blocks of the flowchart 700, and combinations of blocks in the flowchart 700, can be implemented by special-purpose hardware-based computer systems which perform the specified functions, or combinations of special-purpose hardware and computer instructions.

In some embodiments, the processor 202 may include means for performing each of the operations as mentioned earlier in conjunction with flowchart 700. In this regard, according to an example embodiment, examples of means for performing operations may comprise, for example, the processor and/or a device or circuit for executing instructions or executing an algorithm for processing information as described above.

FIG. 8 illustrates an exemplary map database record storing data, in accordance with an embodiment of the disclosure. FIG. 8 is explained in conjunction with elements from FIG. 1, FIG. 2, FIG. 3A, FIG. 3B, FIG. 3C, FIG. 4, FIG. 5, FIG. 6, and FIG. 7. With reference to FIG. 8, there is shown a format of the map data 800 stored in the map database 108B according to one or more example embodiments. FIG. 8 shows a link data record 802 that may be used to store data associated with one or more of the feature lines. This link data record 802 may include information (such as “attributes”, “fields”, etc.) associated with it that may allow identification of the nodes associated with the link and/or the geographic positions (e.g., the latitude and longitude coordinates and/or altitude or elevation) of the two nodes. In addition, the link data record 802 may include information (e.g., more “attributes”, “fields”, etc.) that may specify the permitted speed of travel on a portion of the road may be represented by the link record, the direction of travel permitted on the road portion may be represented by the link record, if any turn restrictions may exist at each of the nodes corresponding to intersections at the ends of the road portion may be represented by the link record, the street address ranges of the roadway portion may be represented by the link record, the name of the road, and so on. The various attributes associated with a link may be included in a single data record or are included in more than one type of record which are referenced to each other.

Each link data record that may represent other-than-straight road segment may include shape point data. The shape point is a location along a link between its endpoints. To represent the shape of other-than-straight roads, the mapping platform 108 and its associated map database developer may select one or more shape points along the other-than-straight road portion. The shape point data may be included in the link data record 802 indicative of the position, (e.g., latitude, longitude, and optionally, altitude or elevation) of the selected shape points along the represented link.

Additionally, in the compiled geographic database, such as a copy of the map database 108B, there may also be a node data record 804 for each node. The node data record 804 may be associated with information (such as “attributes”, “fields”, etc.) that may allow identification of the link(s) that may connect to it and/or its geographic position (e.g., its latitude, longitude, and optionally altitude or elevation).

In some embodiments, compiled geographic databases may be organized to facilitate the performance of various navigation-related functions. One way to facilitate performance of navigation-related functions may be to provide separate collections or subsets of the geographic data for use by specific navigation-related functions. Each such separate collection may include the data and attributes needed for performing the associated function but may exclude data and attributes that may not be needed for performing the function. Thus, the map data may be alternately stored in a format suitable for performing types of navigation functions, and further may be provided on-demand, depending on the type of navigation function.

FIG. 9 illustrates another exemplary map database record storing data, in accordance with an embodiment of the disclosure. FIG. 9 is explained in conjunction with elements from FIG. 1, FIG. 2, FIG. 3A, FIG. 3B, FIG. 3C, FIG. 4, FIG. 5, FIG. 6, FIG. 7, and FIG. 8. With reference to FIG. 9, there is shown another format of the map data 900 stored in the map database 108B according to one or more example embodiments. In the FIG. 9, the map data 900 is stored by specifying a road segment data record 902. The road segment data record 902 is configured to represent data that represents a road network. In FIG. 9, the map database 108B contains at least one road segment data record 902 (also referred to as “entity” or “entry”) for each road segment in a geographic region.

The map database 108B that represents the geographic region of FIG. 8 may also include node data records 904 (a node data record 904A and a node data record 904B) (or “entity” or “entry”) for each node associated with the at least one road segment shown by the road segment data record 902. (The terms “nodes” and “segments” represent only one terminology for describing these physical geographic features and other terminology for describing these features is intended to be encompassed within the scope of these concepts). Each of the node data records 904A and 904B may have associated information (such as “attributes”, “fields”, etc.) that may allow identification of the road segment(s) that may connect to it and/or its geographic position (e.g., its latitude and longitude coordinates).

FIG. 9 depicts the components of road segment data record 902 contained in the map database 108B. The road segment data record 902 may include a segment ID 902A by which the data record may be identified in the map database 108B. The segment ID 902A may be associated with its information (such as “attributes”, “fields”, etc.) that may describe features of the represented road segment. The road segment data record 902 may include restriction direction data 902B that may indicate the restrictions, if any, on the direction of vehicular travel permitted on the represented road segment. The road segment data record 902 may include speed limit data 902C that may indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 902 may include 2D geometry data 902D indicative of two-dimensional (“2D”) geometry or shape of the road segment. If a road segment is straight, its shape may be represented by identifying its endpoints or nodes. However, if a road segment is other-than-straight, additional information may be required to indicate the shape of the road. One way to represent the shape of an other-than-straight road segment may be to use shape points. Shape points are points through which a road segment passes between its end points. By providing the latitude and longitude coordinates of one or more shape points, the shape of another-than-straight road segment may be represented. Another way of representing other-than-straight road segment may be with mathematical expressions, such as polynomial splines.

The road segment data record 902 may include road grade data 902E that may be indicative of the grade or slope of the road segment. In one embodiment, the road grade data 902E may include road grade change points and a corresponding percentage of grade change. Additionally, the road grade data 902E may include the corresponding percentage of grade change for both directions of a bi-directional road segment. The location of the road grade change point may be represented as a position along the road segment, such as thirty feet from the end or node of the road segment. For example, the road segment may have an initial road grade associated with its beginning node. The road grade change point may indicate position on the road segment wherein the road grade or slope changes, and percentage of grade change may indicate a percentage increase or decrease of the grade or slope. Each road segment may have several grade change points depending on the geometry of the road segment. In another embodiment, the road grade data 902E may include the road grade change points and an actual road grade value for the portion of the road segment after the road grade change point until the next road grade change point or end node. In an embodiment, the road grade data 902E may include elevation data at the road grade change points and nodes. In an alternative embodiment, the road grade data 902E may be an elevation model which may be used to determine the slope of the road segment.

The road segment data record 902 may include or be associated with other data 902F that may refer to various other attributes of the represented road segment. The various attributes associated with a road segment may be included in a single road segment record or may be included in more than one type of record which cross-reference of each other. For example, the road segment data record 902 may include data identifying the name or names by which the represented road segment is known, the street address ranges along the represented road segment, and or the like.

The road segment data record 902 may include endpoints 902G providing the geographic coordinates (e.g., the latitude and longitude) of the end points of the represented road segment. In one embodiment, the endpoints 902G may be references to the node data records 904 that may represent the nodes corresponding to the end points of the represented road segment.

FIG. 9 may represent components of the node data records 904 contained in the map database 108B. Each of the node data records 904 may include associated information (such as “attributes”, “fields”, etc.) that may allow identification of the road segment(s) that may connect to it and/or it is geographic position (e.g., its latitude and longitude coordinates). For the embodiment shown in FIG. 9, the node data records 904 including 904A and 904B that may include the latitude and longitude coordinates 904A1 and 904B1 for their nodes accordingly. The node data records 904 including 904A and 904B may also include other data 904A2 and 904B2 that may refer to various other attributes of the nodes.

Thus, the overall data stored in the map database 108B may be organized in the form of different layers for greater detail, clarity, and precision. Specifically, in the case of high-definition maps, the map data may be organized, stored, sorted, and accessed in the form of three or more layers. The layers may include road level layer, lane level layer and localization layer. The data stored in the map database 108B may be stored in the formats shown in FIG. 8 and FIG. 9. The data stored in the map database 108B may be combined in a suitable manner to provide these three or more layers of information. In an embodiment, there may be lesser or fewer number of layers of data possible, without deviating from the scope of the present disclosure.

FIG. 10 illustrates another block diagram 1000 of the map database 108B storing data, in accordance with an embodiment of the disclosure. The map database 108B may store map data or geographic data 1010 in the form of road segments/links, nodes, and one or more associated attributes as discussed above. Furthermore, attributes may refer to features or data layers associated with the link-node database, such as an HD lane data layer.

In addition, the geographic data 1010 may include other kinds of data 1006. The other kinds of data 1006 may represent other kinds of geographic features. The other kinds of data 1006 may include point of interest data. For example, the point of interest data may include point of interest records comprising a type (e.g., the type of point of interest, such as restaurant, ATM, etc.), location of the point of interest, a phone number, hours of operation, etc. The map database 108B may include indexes 1008. The indexes 1008 may include various types of indexes that may relate with the different types of data to each other or may relate to other aspects of the data contained in the map database 108B. The road segment data records 1002 is an exemplary embodiment of the road segment data record 902 of FIG. 9. The node data records 1004 is an exemplary embodiment of the node data records 904 of FIG. 9.

The data stored in the map database 108B in the various formats discussed above may help in providing precise data for high-definition mapping applications, autonomous vehicle navigation and guidance, cruise control using ADAS, direction control using accurate vehicle maneuvering and other such services. In an embodiment, the system 102 may be configured to access the map database 108B. The map database 108B may store data in the form of various layers and formats depicted in FIG. 8, FIG. 9 and FIG. 10. The map database 108B may additionally store the image data and the optimized model used for inference deduction that may be accessed by the user device for faster processing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A system, comprising:
a memory to store computer-executable instructions; and
one or more processors coupled to the memory, wherein the one or more processors are configured to:
receive trip data associated with each of a plurality of data points of a trip segment of a trip, wherein the trip data comprises speed data and location data;
determine a deceleration condition associated with a set of consecutive data points of the plurality of data points, wherein the set of consecutive data points terminate at an end point of the plurality of data points;
in response to determining the deceleration condition, determine a geographical region associated with the set of consecutive data points based on the location data of each data point of the set of consecutive data points;
determine the geographical region to be associated with a point of interest (POI) location;
determine, using a machine learning (ML) model, a probability value for occurrence of a stop event of the trip based on the determined geographical region to correspond to the POI location; and
based on the determination of the probability value to be greater than a threshold value, store the trip data in association with the stop event of the trip.

2. The system of claim 1, wherein the trip data is associated with the trip of a vehicle, and wherein the deceleration condition is associated with the deceleration of the vehicle.

3. The system of claim 2, wherein the one or more processors are further configured to:
identify the set of consecutive data points, wherein the set of consecutive data points comprises a pre-defined number of consecutive data points of the plurality of data points; and
determine a first value associated with the set of consecutive data points based on the speed data associated with each data point of the set of consecutive data points, wherein the first value indicates one of: an acceleration of the vehicle, or the deceleration of the vehicle.

4. The system of claim 2, wherein on determining the geographical region to be associated with the POI location, the one or more processors are further configured to:
determine a time period associated with the stop event of the vehicle within a vicinity of the POI location;
compare the time period of the stop event with a time threshold; and
determine the POI location to be associated with a parking area based on the comparison.

5. The system of claim 1, wherein the one or more processors are further configured to:
obtain map data, wherein the map data comprises a plurality of POI locations;
compare the determined geographical region with each of the plurality of POI locations; and
determine the geographical region to be associated with the POI location of the plurality of POI locations based on the comparison.

6. The system of claim 1, wherein the trip segment is associated with a trip identifier.

7. The system of claim 2, wherein the trip data further comprises lane information of the vehicle associated with each of a plurality of data points, and orientation information of the vehicle associated with each of a plurality of data points.

8. The system of claim 7, wherein the one or more processors are further configured to:
determine, using the ML model, the probability value for the occurrence of the stop event based on the lane information of the vehicle associated with each of the set of consecutive data points, and the orientation information of the vehicle associated with each of the set of consecutive data points

9. The system of claim 1, wherein the one or more processors are further configured to:
receive historical data associated with the POI location;
determine vehicle data associated with the POI location based on historical data, wherein the vehicle data is associated with one or more parked vehicles within a threshold distance from the POI location; and
determine, using the ML model, the probability value associated with the occurrence of the stop event of the trip based on the vehicle data.

10. The system of claim 1, wherein the one or more processors are further configured to:
re-train the ML model based on the trip data, and historical data associated with the POI location; and
store the re-trained ML model.

11. The system of claim 1, wherein the ML model is trained on a historical trip data associated with one or more vehicles, and wherein the one or more processors are further configured to:
train the ML model based on the historical trip data to determine the probability value for the occurrence of the stop event of the trip.

12. The system of claim 1, wherein the one or more processors are further configured to:
determine POI information from map database;
generate, using the ML model, a label corresponding to the trip segment, wherein the labels indicates the POI information corresponding to the stop event; and
store the trip data in association with the labels.

13. A method, comprising:
receiving trip data associated with each of a plurality of data points of a trip segment of a trip, wherein the trip data comprises speed data and location data;
determining a deceleration condition associated with a set of consecutive data points of the plurality of data points, wherein the set of consecutive data points terminate at an end point of the plurality of data points;
in response to determining the deceleration condition, determining a geographical region associated with the set of consecutive data points based on the location data of each data point of the set of consecutive data points;
determining the geographical region to be associated with a point of interest (POI) location;
determining, using a machine learning (ML) model, a probability value for occurrence of a stop event of the trip based on the determined geographical region to correspond to the POI location; and
based on the determination of the probability value to be greater than a threshold value, storing the trip data in association with the stop event of the trip.

14. The method of claim 13, wherein the method further comprising:
identifying the set of consecutive data points, wherein the set of consecutive data points comprise a pre-defined number of consecutive data points of the plurality of data points; and
determining a first value associated with the set of consecutive data points based on the speed data associated with each data point of the set of consecutive data points, wherein the first value indicates one of: an acceleration of a vehicle, or a deceleration of the vehicle.

15. The method of claim 14, wherein on determining the geographical region to be associated with the POI location, the method further comprising:
determining a time period associated with the stop event of the vehicle within a vicinity of the POI location;
comparing the time period of the stop event with a time threshold; and
determining the POI location to be associated with a parking area based on the comparison.

16. The method of claim 13, wherein the method further comprising:
obtaining map data, wherein the map data comprises a plurality of POI locations;
comparing the determined geographical region with each of the plurality of POI locations; and
determining the geographical region to be associated with the POI location of the plurality of POI locations based on the comparison.

17. The method of claim 14, wherein the trip data further comprises lane information of the vehicle associated with each of a plurality of data points, and orientation information of the vehicle associated with each of a plurality of data points.

18. The method of claim 13, wherein the ML model is trained on a historical trip data associated with one or more vehicles, and wherein method further comprising:
training the ML model based on the historical trip data to determine the probability value for the occurrence of the stop event of the trip.

19. A computer programmable product comprising a non-transitory computer readable medium having stored thereon computer executable instructions, which when executed by one or more processors, cause the one or more processors to conduct operations, comprising:
receiving trip data associated with each of a plurality of data points of a trip segment of a trip, wherein the trip data comprises speed data and location data;
determining a deceleration condition associated with a set of consecutive data points of the plurality of data points, wherein the set of consecutive data points terminate at an end point of the plurality of data points;
in response to determining the deceleration condition, determining a geographical region associated with the set of consecutive data points based on the location data of each data point of the set of consecutive data points;
determining the geographical region to be associated with a point of interest (POI) location;
determining, using a machine learning (ML) model, a probability value for occurrence of a stop event of the trip based on the determined geographical region to correspond to the POI location; and
based on the determination of the probability value to be greater than a threshold value, storing the trip data in association with the stop event of the trip.

20. The computer programmable product of claim 19, wherein the operations further comprise:
identifying the set of consecutive data points, wherein the set of consecutive data points comprises a pre-defined number of consecutive data points of the plurality of data points; and
determining a first value associated with the set of consecutive data points based on the speed data associated with each data point of the set of consecutive data points, wherein the first value indicates one of: an acceleration of a vehicle, or a deceleration of the vehicle.
